(19) United States
(12) Patent Application Publication
(10) Pub. No.: US 2010/0091048 A1
(43) Pub. Date: Apr. 15, 2010

(54) FRAME SYNCHRONIZATION OF PULSE-WIDTH MODULATED BACKLIGHTS

(75) Inventors: Andrew P. Aitken, Cupertino, CA (US); Paolo Sacchetto, Cupertino, CA (US); Jason Gomez, Cupertino, CA (US); David Lum, Cupertino, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/579,261

(22) Filed: Oct. 14, 2009

Related U.S. Application Data
(60) Provisional application No. 61/105,396, filed on Oct. 14, 2008.

(51) Int. Cl. G06F 3/038; G09G 5/10

(52) U.S. Cl. 345/690; 345/213

(57) ABSTRACT

An apparatus for controlling backlighting of an electronic display, such as a liquid crystal display (LCD) panel. The apparatus may synchronize a power cycle of one or more light-emitting diode (LED) strings to a frame rate of the LCD panel.

### CROSS-REFERENCE TO RELATED APPLICATIONS

This application claims priority under 35 U.S.C. §119 to U.S. Provisional Application No. 61/105,396, titled “Frame Synchronization of Pulse-Width Modulated Backlights” and filed on Oct. 14, 2009, the entirety of which is incorporated herein as if fully set forth.

### BACKGROUND

1. Technical Field

The present invention relates generally to electronic displays, and more particularly to electronic displays having backlighting provided by light-emitting diodes.

2. Background Discussion

Many displays based on liquid crystal display (LCD) technology filter light from a light source called a backlight through an LCD panel to produce images on their display screen. Backlights illuminate the LCD panel from the back, and each pixel of the LCD filters the light differently to produce a picture. Backlights can be provided in various colors. For example, color LCD displays may use white backlights, and monochrome LCD displays can have colored or white backlights. The backlight can usually be adjusted to produce a light level in a range from dark to full brightness. The level of full brightness achievable depends on the backlight.

A light emitting diode (LED) backlight source can also improve the color range of a LCD display. LED white light can produce a color spectrum closely matching the color range of the LCD pixel filters. The light from the LEDs can also have a wider spectrum than light from certain other light sources, providing richer, brighter colors.

Although LCD display screens may be backlit by fluorescent lights or electroluminescent panels, LEDs are increasingly being used to provide backlighting and are an efficient and durable method of lighting. LEDs have a long operating life, relatively low power consumption, and a broad color range.

Frame rate refers to the frequency at which an imaging device produces unique consecutive images (frames). Frame rate is most often expressed in frames per second or Hertz (Hz). The higher the number of frames per second, the smoother the video displayed appears to the user. Lower frame rates typically result in lower video quality and higher rates typically yield better video quality. As a reference, motion pictures typically use 24 frames/second (24 Hz), the American TV standard (NTSC) uses 60 frames/second (60 Hz), and the European TV standard (PAL) uses 50 frames/second (50 Hz) to allow the viewer to perceive smooth playback.

The frame refresh rate for an LCD display refers to the number of times per second (Hz) that the display hardware redraws the image on the screen. This frame rate is controlled by LCD timing signals. The display frame rate may differ from the video content frame update rate, in which case the video source generates more than one display frame for each frame of video content.

LED strings providing backlighting to an LCD display are generally rapidly switched on and off to modulate their output brightness. This switching may be accomplished by modulating the strings' drive current. LCD displays may experience a number of problems which are at least partially due to backlighting, such as flickering, shimmering and banding. For example, flickering can be caused when a LED drive signal frequency is relatively slow compared to the frame rate of an LCD panel. In such situations, there may be substantial portions of a frame that are not backlit at a given instant in time. FIG. 1A illustrates one period of an exemplary LED drive signal 102 and two periods of an exemplary LCD refresh signal 104 (also known as a vertical synchronization signal or VSYNC signal 104). Note, in this example, two periods of the VSYNC signal 104 correspond to one video content frame. As shown in FIG. 1A, the second half of the image frame will have no backlight and, hence, will appear darker than the first half of the image frame. This leads to a blinking or “flickering” effect that is undesirable.

As shown in FIG. 1B, when the LCD refresh signal 104 is out of phase with the LED drive signal 102, additional undesired visual effects may appear in the display, such as shimmering. Shimmering refers to an effect that typically occurs when a moving object in the image intersects with a background or object of a different shade. For example, when tree leaves are blowing in the wind, the edges of the leaves may appear to artificially shimmer at the edges of the leaves. The cause of shimmering is similar to that of flickering but is further caused by a phase offset 106 between the LED drive signal 102 and the LCD refresh signal 104, as shown in FIG. 1B. Shimmering typically occurs when this phase offset 106 drifts or changes in time.

Further, in many LCD displays having a relatively slow frame rate, such as 60 Hz, the panel experiences optical decay in the displayed image between frame refreshes. Thus, during each frame refresh, the optical properties of the displayed image may change slightly as the image is refreshed, row by row. When combined with the on-off nature of the LED illumination this results in a banding artifact visible on the display screen This banding is particularly noticeable when the number of backlight cycles per frame is small and the phase offset 106 does not drift or change significantly in time. The result is slow moving or stationary bands of light or dark areas across the display screen which reduce the visual quality of the displayed image.

Further, in certain LCD panels having LED backlights, the on/off cycle (or “duty cycle”) of the LEDs may differ from the refresh rate of the LCD display in such a way that the interaction of backlight frequency and refresh frequency may then cause a beating phenomena where the banding artifact is particularly mobile and also easily visible to the eye. Typically, the beating phenomena takes the form of what is colloquially called a “waterfall” effect because the displayed image appears somewhat as if viewed through running water. The waterfall effect is generally distracting and annoying to a viewer and may cause the viewer to believe the display is defective.

Accordingly, there is a need in the art for an improved LED-backlit electronic display.

### SUMMARY

Generally, one embodiment takes the form of an apparatus for controlling backlighting of an electronic display, such as a liquid crystal display (LCD) panel. The apparatus may synchronize a power cycle of one or more light-emitting diode (LED) strings to a frame rate of the LCD panel.

One sample embodiment may take the form of a method for synchronizing backlighting of an electronic display to a frame refresh rate, including the operations of: initiating a counter at an initial value; upon the counter reaching a first value, generating a pulse-width modulated input to a light-emitting diode, the light-emitting diode backlighting the display when active; upon the counter reaching a second value, terminating the pulse-width modulated input, thereby turning off the light-emitting diode; receiving a frame refresh indicator; and in response to receiving the frame refresh indicator, resetting the counter to the initial value. Such an embodiment may further include the operation of, upon the counter reaching a third value, setting the counter to the initial value.

### BRIEF DESCRIPTION OF THE FIGURES

FIG. 1A depicts a conventional signal diagram showing an LED drive signal operating at a lower frequency than a corresponding LCD refresh signal.

FIG. 1B depicts a conventional signal diagram showing a phase offset of an LED drive signal from a corresponding LCD refresh signal.

FIG. 2A is a cross-sectional side view of an LCD display in accordance with a first embodiment.

FIG. 2B is a cross-sectional view of the LCD display of FIG. 2A, taken along line 2B-2B of FIG. 2A.

FIG. 3 is a timing diagram showing the active and inactive states of a number of LED strings providing backlighting for an electronic display, in accordance with the first embodiment.

FIG. 4 is a schematic diagram of a portion of the first embodiment.

FIG. 5 is a timing diagram showing an alternative arrangement of active and inactive states for a number of LED strings providing backlighting for an electronic display.

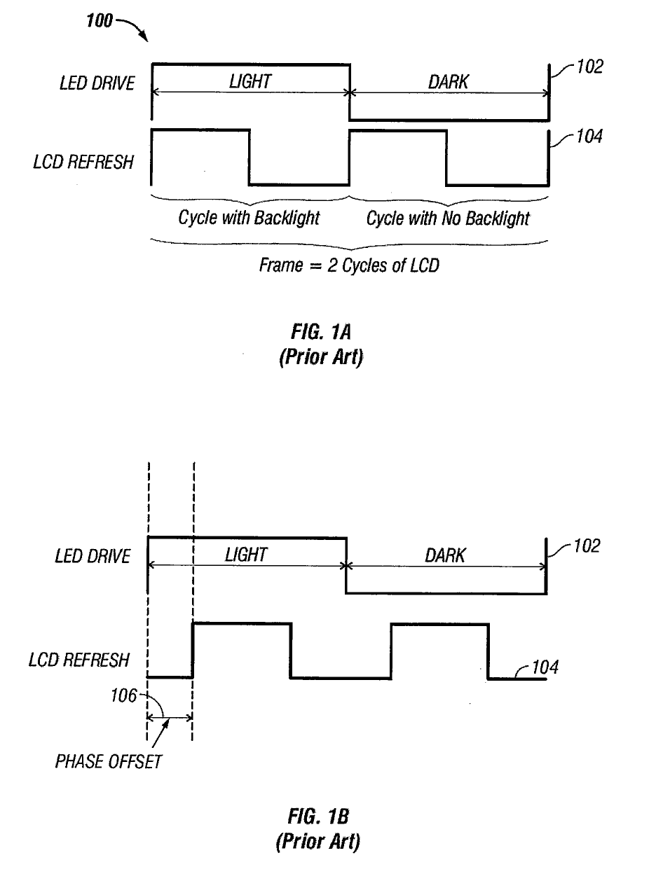

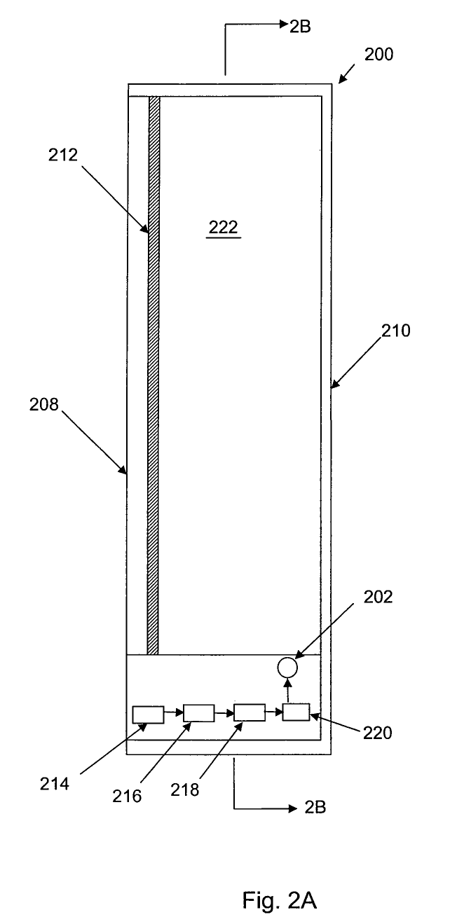

### DETAILED DESCRIPTION

Generally, one embodiment takes the form of an apparatus for controlling backlighting of an electronic display, such as a liquid crystal display (LCD) panel. Generally, the apparatus may synchronize a power cycle of one or more light-emitting diode (LED) strings to a frame rate of the LCD panel. An LED string is a group of one or more LEDs generally connected in series and powered by a common input signal. As used herein, the terms “panel” and “display,” when used as a noun, are generally interchangeable.

The frame rate may be dictated by, for example, the hardware of the LCD display. Many LCD panels are configured to refresh (e.g., redraw) the entirety of the display 60 times a second, thus yielding a frame rate of 60 Hz. Typically, a VSYNC pulse is inserted between the end of one set of image data (e.g., a frame) and the beginning of the next set of image data to indicate the transition from one frame to the next. The length of the vertical synchronization pulse, or VSYNC signal, may vary depending on the configuration, capabilities and hardware of the LCD panel and/or computing system connected thereto. The VSYNC pulse therefore acts as a refresh signal by indicating the transition between frames for the LCD display.

In the present embodiment, the power cycle of the LED strings may be controlled via pulse-width modulation. By varying the on-to-off ratio of the LED strings, the brightness of the LCD display may be controlled. Increasing the on-to-off ratio increases LCD display brightness, while decreasing the ratio decreases the brightness. The embodiment may vary the on-to-off ratio through pulse-width modulating the input signal to the LED strings. Pulse-width modulation (“PWM”) generally varies the duty cycle of a signal, in this case the supply current (e.g., input signal) to the LED strings. In the present embodiment, pulse-width modulation varies the LEDs' supply current between on and off states, also known as duty cycling. Within each duty cycle is a time during which the LED string is passing current and driven on (e.g., illuminated) and a time during which the LED string is not driven and off (e.g., dark). The ratio of the on time to the off time is the duty cycle ratio and determines the perceived brightness of the LED string

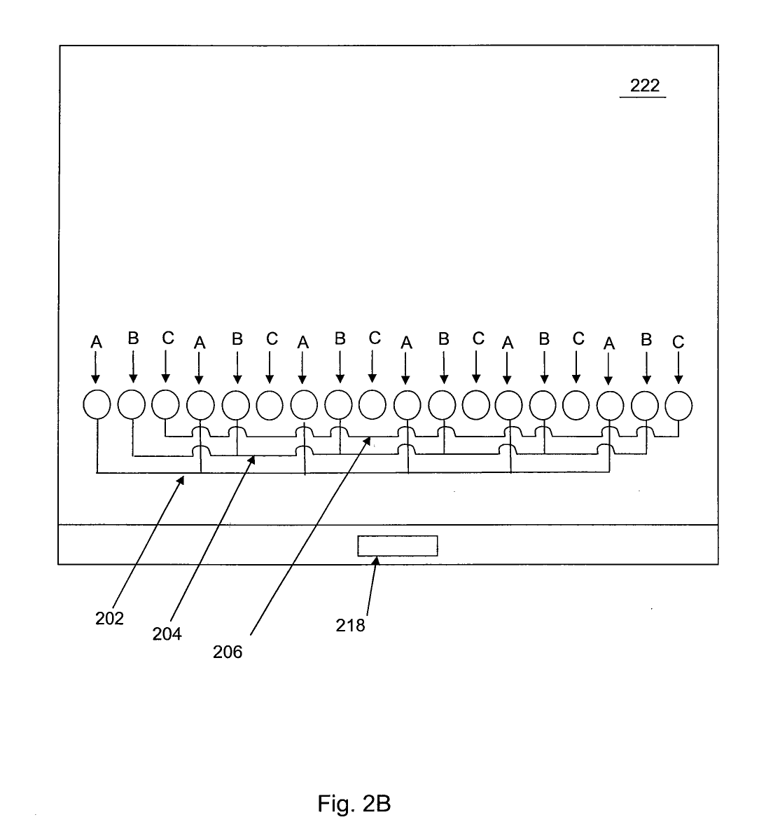

As shown to best effect in FIGS. 2A and 2B, a single LCD panel 200 may have multiple LED strings 202, 204, 206 that provide backlighting and assist in brightness control. Although the LCD display 200 shown in FIGS. 2A and 2B uses three LED strings, alternative embodiments may employ more or fewer LED strings. One embodiment, for example, may use a single LED string while another embodiment may use six strings. The number of LED strings employed may affect the overall duty cycle of each string during operation of the embodiment. By contrast, the active duty cycle may be user-specified to control the overall display brightness or set to some default value, such as 80%.

With respect to the cross-sectional side view of FIG. 2A, the LCD display 200 includes an LCD panel 208 generally forming the front of the display. The rear of the display may include a reflective element 210, which acts to reflect light impacting the rear of a diffuser 222 back into the diffuser 222. The light input to the diffuser 222 is generated by the various LED strings 202, 204, 206. (Given the angle of cross-section, only one LED string 202 can bee seen in FIG. 2A; all are shown in FIG. 2B.) The diffuser 222 is generally located between the reflective element 210 and optical film 212. The diffuser 222 diffuses light emitted by the LED strings to evenly spread this light around the front emitting surface of the display 200.

The LED strings themselves are, in the embodiment shown, located beneath the diffuser 222; FIG. 2B depicts the layout of the LED strings in a simplified cross-section taken along line 2B-2B of FIG. 2A. Other arrangements of LED strings are possible than the one shown in this embodiment For example, in some embodiments the LEDs are located along more than one edge of the diffuser. Returning to the embodiment shown in FIGS. 2A and 2B, the three LED strings 202, 204, 206 are interleaved such that every third LED belongs to the same string. That is, all LEDs marked “A” are part of LED string 202, all LEDs marked “B” are part of the second LED string 204 and all LEDs marked “C” are part of the third LED string 206. By interleaving the LED strings in this manner, the embodiment prevents or reduces flicker or shifting of backlighting as the strings are PWM duty cycled.

Each of the LEDs in the LED strings 202, 204, 206 generally emit light hemispherically. That is, each LED generally acts as a more or less omnidirectional point source within the hemispherical space above the LED. One or more shaped reflectors (not shown) may therefore be located adjacent or near each LED to reflect emitted light upward into the diffuser 222. For example, a first parabolic reflector and second parabolic reflector may be placed on either side of an LED, generally partially surrounding the LED and reflecting emitted light upwards. Such reflectors may extend only partially upward along the height of the LED in question. Further, light may be reflected by the optional reflective element 210 and directed back into the diffuser 222 in order to provide greater backlighting to the screen. Situated between the reflective element 210 and LCD panel 208 may be an optical film or layer 212. The optical layer generally directs any light impacting it toward the LCD screen such that the light impacts the rear of the screen generally at a more perpendicular angle than would occur without the optical layer being present. The optical layer 212 thus bends light entering it in much the same manner as a lens.

The display 200 may also include a counter 214 and one or more registers 216. The exact physical location of the counter 214 and/or registers 216 is irrelevant to the construction or operation of the embodiment; the positioning shown in FIG. 2A is intended as an example only. Further, the registers may be implemented in the counter itself. Alternately, the registers may take the form of one or more integrated circuits accessible by the counter, as shown. As discussed in more detail below, each register 216 may be connected to one or more latches 218 each of which, in turn, generates a PWM output that is fed to a driver device 220. The driver device 220 produces a PWM drive signal for an associated LED string from the latch's output. The PWM input signal may be at a voltage of sufficient magnitude as needed to operate the associated LED string by causing a current of appropriate magnitude to flow in the LED string. In addition, it should be noted that the counter 214, register(s) 216, latch(es) 218 and driver device(s) 220 may be located as necessary within the display 200, in certain embodiments, in a computing system associated with the display, or alternatively elsewhere outside the physical housing of the display. It should likewise be noted that the counter 214 may be implemented in hardware or software, as desired.

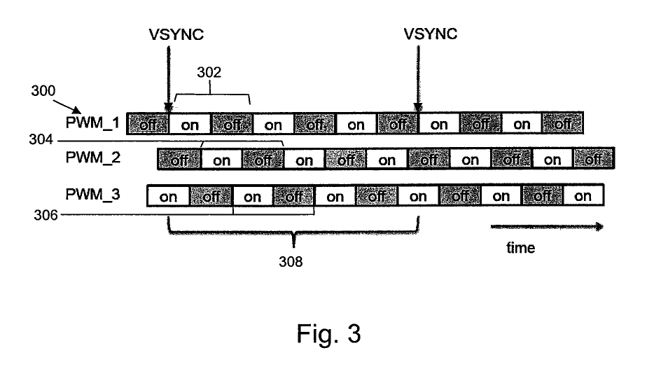

As previously mentioned, certain embodiments of the present invention may duty cycle the LED strings 202, 204, 208, 208 by pulse-width modulating the input current 300 to the strings, as shown in FIG. 3. In one embodiment, the active duty cycles of each of the LED strings are out of phase with each of the other strings' active duty cycles. For example, in an embodiment having three LED strings, the active duty cycles of each LED string may be phase offset from one another by 120 degrees. That is, no duty cycle of any LED string is offset by less than 120 degrees from any other LED string's duty cycle. That is, and still with respect to FIG. 3, the embodiment may employ a first LED string 202 having a first active duty cycle 302 that is initially active for a fixed time T. The second LED string 204 may have a second active duty cycle 304 also active for time T, but 120 degrees out of phase with the first duty cycle. The third LED string 206 exhibits a third active duty cycle 306 again active for time T and 120 degrees out of phase with the second duty cycle, as well as 240 degrees out of phase with the first duty cycle. Generally, the phase offset of the LED strings' duty cycles may be expressed as N/X, where N is an arbitrary, constant integer and X is the number of LED strings. For simplicity's sake, N is often set to 360 and this discussion will use such a value. The LED strings' output may define a repeating sequence of duty cycles 308 which occur within a single VSYNC defined frame.

In order to avoid the aforementioned waterfall effect, an embodiment may synchronize the timing of the PWM signals to the timing of the display's video frame, such that the overall duty cycle of the LED strings (or a cycle of overall duty cycles) begins and ends with the beginning and end of the video frame. Since the VSYNC signal signifies the end of one video frame and the beginning of another, certain embodiments may use the VSYNC signal to synchronize or generate the PWM signals for the LED strings.

It should be noted that every display has a fixed VSYNC signal length; the VSYNC timing is determined externally to the display by an video signal timing input. This video signal timing input is generally created by and transmitted from the video source associated with the display. Further, it should be noted that the VSYNC frequency may vary slightly due to variations in the timing of this external video source. Accordingly, certain embodiments may dynamically adjust the PWM signals (and thus the active duty cycles of the LED strings) to initially estimate the timing of the VSYNC signal and, as the embodiment operates, dynamically change the PWM signals as necessary to account for the aforementioned variations.

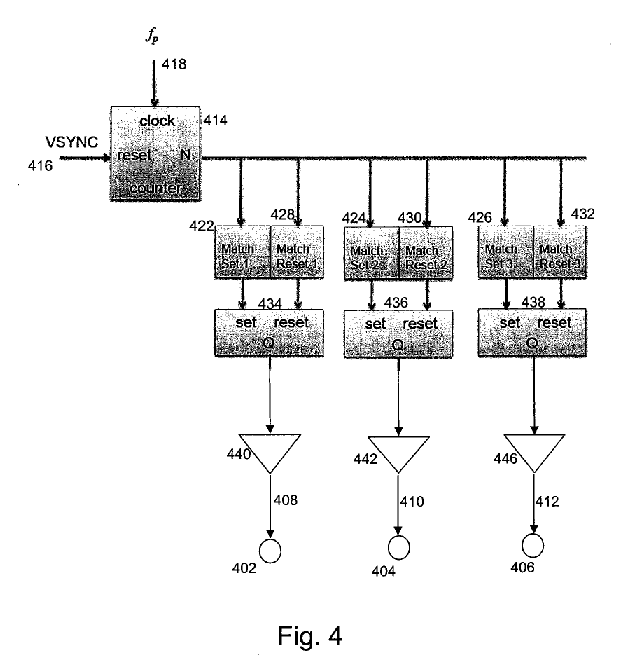

One way to synchronize the PWM input signals of the LED strings to the VYNC pulse is to use the VSYNC pulse to generate the PWM signals. Instead of merely synchronizing the PWM signals using a phase-locked-loop to lock the PWM timing to the VSYNC pulse, the embodiment shown in FIG. 4 employs the VSYNC signal to initiate and terminate the set of PWM signals driving the LED strings.

Typically, each LED string 402, 404, 406 receives a separate PWM input signal 408, 410, 412 from a unique driver device 440, 442, 446. This permits phase shifting of the LED strings with respect to one another. The generation of the PWM signals will now be discussed.

A counter 414 generally receives the VSYNC signal 416 and a timing clock (denoted by fₚ) 418 as inputs. Generally, the output 420 of the counter starts at zero and is incremented by one for each pulse of the timing clock 418. When the output 420 reaches a certain terminal-count value, the counter resets the output to zero and repeats the process of incrementing the output from zero to the terminal-count value.

In addition, the VSYNC signal 416 is used as a reset signal for the counter 414. That is, every time the VSYNC signal occurs (e.g., transitions high), the counter resets its output 420 to zero. Thus, the timing clock 418 establishes the speed and incrementing of the output 420, while the VSYNC signal 416 acts as an additional mechanism for resetting the output. In this manner, the counter output 420 and, by extension, the PWM inputs to each LED string are clamped in time to the VSYNC signal. Accordingly, the operation of the LED strings is synchronized to the VSYNC signal of the display and graphical artifacts, such as flicker or the aforementioned waterfall effect, may be reduced or minimized.

The output 420, in turn, is received by various set 422, 424, 426 and reset 428, 430, 432 registers. Each set register is matched to a reset register to create a register pair. Each register pair, in turn, is electrically connected to a latch 434, 436, 438.

Every register (either set or reset) contains a certain value. When the output 420 equals that value, a signal is sent from the corresponding register to the latch. If the register is a set register, then the latch begins outputting a PWM signal to drive its associated LED string. If the register is instead a reset register, the latch ceases outputting the PWM signal, thereby driving the LED string to a quiescent or inactive state. Accordingly, by varying the values stored in the set registers and/or reset registers, the duration of the PWM signal may be varied. While the PWM signal is supplied to an LED string, the LED string is said to be “active.” Likewise, when the PWM signal is low, the LED string is inactive.

The result of the foregoing is that each LED string receives a PWM input current for a certain time defined initially by the timing clock 418 and the values of the LED string's corresponding set register 422 and reset register 426. As one example, consider an embodiment having three LED strings and the following values for each set and reset register:

| | Set Register Value | Reset Register Value |
|---|---|---|
| LED String 1 | 0 | 180 |
| LED String 2 | 120 | 300 |
| LED String 3 | 240 | 60 |

Also presume the embodiment has a terminal-count value of 360, such that the counter 414 resets its output 420 to zero whenever it reaches 360. The output of such an embodiment is generally the timing diagram shown in FIG. 3. It should be noted that the counter increment is arbitrarily chosen for this example and could be any number desired.

In this example, the counter output 420 would climb from zero to 360, incrementing at a rate equal to the change in the clock input fₚ. At a count of 360, the counter 414 would reset its output 420 to zero.

As the output 420 begins its count at zero, the first set register would trigger, thereby instructing the first latch, via its associated driver device, to output a PWM signal to the first LED string. In response, the LED string would activate, providing backlighting to the associated LED panel. The second LED string would begin its active duty cycle when the counter output reaches 120, since its set register would instruct the second latch and second driver device to produce a PWM signal at count 120. Then, at a count of 180, the first reset register would trigger, instructing the first latch to cease its PWM signal to the first LED string. The first LED string would thus enter an inactive state and remain in this inactive state until the output 420 again reaches zero and the first set register triggers.

When the counter output reaches 240, the third set register would activate the third latch and, in turn, the third driver device, thereby driving the third LED string to illuminate the LCD display. At an output count of 300, the second reset register would trigger, deactivating the second latch and thus the second LED string.

When the output 420 reaches a count of 360, the counter 414 resets the output to zero, thus again activating the first LED string. In addition, when the output reaches a count of 60, the third reset register triggers, turning off the third latch and the third LED string. It should be noted that the third reset register would trigger the first time the system operates and the output reaches 60. However, since the third LED string would be off in this state, there would be no change in the LED string's status.

Eventually, the counter 414 will receive the active edge (e.g., rising edge) or active state of the VSYNC signal. When this occurs, the counter 414 resets its output 420 to zero regardless of its current count. Thus, the VSYNC signal acts to determine the overall frame period of the PWM outputs and thereby synchronize the PWM operation of the LED strings to the refresh rate of the LCD display. Since the counter 414 resets its output 420 in this manner only on the active edge of the VSYNC signal, it operates normally as described previously throughout an entire frame period or cycle of the LCD panel, between successive VSYNC active edges.

Typically, a register controls the associated latch to begin or cease an output PWM signal by applying a signal, as necessary, to an appropriate input on the latch. The operation of latches is well known to those skilled in the art.

Generally, for any configuration of an embodiment, the timing clock rate may be expressed as:

fₚ=(frame refresh rate)×(terminal-count value)×(number of PWM cycles per frame).

Thus, in the foregoing example, fₚ=(60 Hz)×360×3, or 64.8 kHz. It should be appreciated that embodiments may include a very high number of on/off cycles for each LED string. Certain embodiments may operate such that each LED string experiences many hundreds of overall duty cycles in each frame (e.g., between frame refreshes).

An overall duty cycle of 100%, or near 100%, may be achieved in a number of fashions. First, the reset value may be made one count less than the set value. Thus, immediately after the reset value is reached and the reset register triggers deactivation of the latch, the set value is reached and the set register initiates latch operation. As another option, the set and reset values may be made identical to each other and the latch may be configured to operate to set in the event both signals are simultaneously received. As a third option, the reset register value may be set to be greater than the terminal-count value. In this manner, the output 420 will reset to zero before it ever reaches the reset register value and the latch will never cease outputting its PWM signal in an always active state.

Embodiments may also account for any timing discrepancies, such as any initial mismatch between an integral number of PWM cycles and the VSYNC defined frame period, or for drifts in the relative timing of VSYNC and the timing clock function fₚ. One way to account for such timing discrepancies is to adjust any of the counter's terminal-count value, the set register values and the reset register values. A control loop may be implemented in certain embodiments that monitors both VSYNC and PWM timing to update and/or adjust one or more of the aforementioned values so as to reduce the timing discrepancies. Such a control loop may be used, for example, upon startup of an embodiment to determine if the repeating frame sequence of the LED strings is sufficiently matched in duration with the frame refresh rate of the LCD display, where the refresh rate is indicated by the timing of the VSYNC signal. For example, certain embodiments may match or nearly match the VSYNC frame period to an integral number of PWM duty cycles. In such an embodiment, the aforementioned terminal-count, set and reset values may be dynamically adjusted as necessary to reduce or minimize any unwanted discrepancy between the LED string's repeating PWM sequence(s) and the frame refresh rate. Such a control loop may, as required, also function during normal operation of the embodiment to make adjustments to the register values to compensate for any timing drift between VSYNC and fₚ. Such a control loop is optional and some embodiments may omit it. In some embodiments omitting the control loop, the counter's terminal-count and/or the registers' set and reset values may be updated initially and/or when the backlight brightness is changed. At other times the timing is not monitored or adjusted by a control loop. The timing lock between VSYNC and the PWM duty cycles is still maintained in such an embodiment because the active edge of the VSYNC signal resets the counter every frame, aligning the PWM duty cycles to VSYNC.

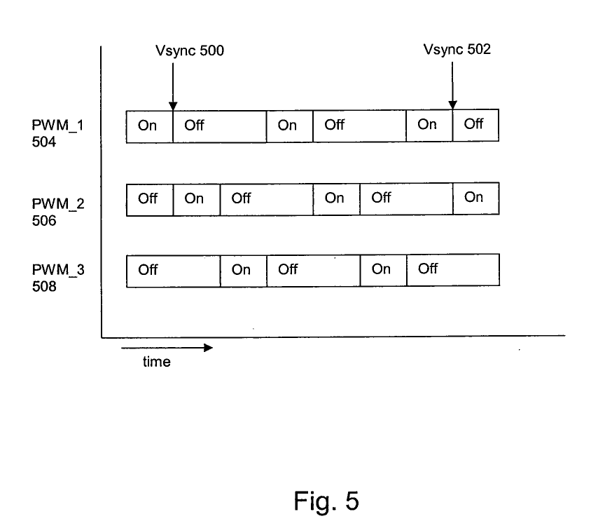

The example shown in FIG. 3 has a repeating frame sequence that begins and terminates during backlighting by an LED string (here, LED string 3). That is, the latch for string 3 is active and generating a PWM signal when the VSYNC active edge is received and the counter resets its output 420 to zero. Alternative embodiments may be configured such that the repeating frame sequence begins and ends at any time within the repeating PWM sequence as defined by the counter terminal-count value and the set and reset values. FIG. 5 shows one example where a first VSYNC pulse 500 defines the beginning of a frame and a second VSYNC pulse 502 defines the frame's end. In that example frame, the first, second and third PWM input signals 504, 506, 508 each have an overall duty cycle of 33%. Continuing the example, the time during which any PWM input signal is generated (e.g., the “on” state) does not overlap with the generation of any other PWM input signal. Accordingly, in this example, the beginning and end of each frame occurs when the first PWM signal 504 is transitioning from an “on” state to an “off” state, the second PWM signal 506 is transitioning from “off” to “on,” and the third PWM signal 508 is off. In this way it can be understood that any relative fixed-offset timing between VSYNC and the PWM duty cycles can be defined by appropriately setting the counter terminal-count and set and reset register values.

It should be noted that alternate embodiments may be used with more than just LCD displays, although the foregoing discussion was provided generally with respect to LCD displays for simplicity's sake. Alternative embodiments may be used in any electronic display that requires or employs backlighting and where there is a frame refresh action driving and/or refreshing the contents of the display panel. Further, the number of LED strings, exact configuration of the registers, latches and/or strings, and so forth may vary in alternate embodiments. Likewise, it should be understood that the duty cycles, various timings and other signal values are provided as examples and may change in other embodiments. Yet other embodiments may employ the falling edge (e.g., transition low) of the VSYNC signal as a counter reset. Accordingly, the proper scope of the present invention is defined by the following claims.

We claim:

1. A method for synchronizing backlighting of an electronic display to a frame refresh rate, comprising:
incrementing a counter starting at an initial value;
upon the counter reaching a first value, generating an input to activate a first light-emitting diode, the light-emitting diode backlighting at least a portion of the display when active;
upon the counter reaching a second value, terminating the input, thereby deactivating the first light-emitting diode;
receiving a refresh indicator; and
in response to receiving the refresh indicator, resetting the counter to the initial value.

2. The method of claim 1, further comprising the operation of, upon the counter reaching a third value, setting the counter to the initial value.

3. The method of claim 2, further comprising the operations of:
upon the counter reaching a fourth value, generating a second input to activate a second light-emitting diode, the light-emitting diode backlighting at least a second portion of the display when active; and
upon the counter reaching a fifth value, terminating the second input, thereby deactivating the second light-emitting diode.

4. The method of claim 3, wherein the fifth value is less than the fourth value.

5. The method of claim 3, wherein the first and second inputs are pulse-width modulated signals.

6. The method of claim 1, wherein the first light-emitting diode and second light-emitting diode are active out of phase with one another.

7. The method of claim 1, wherein the refresh indicator is a frame refresh indicator.

8. The method of claim 7, wherein the refresh indicator is the initial edge of a vertical sync pulse.

9. The method of claim 1, further comprising:
after resetting the counter to the initial value, dynamically adjusting at least one of the first value and second value to adjust an activation period of the first light-emitting diode, thereby producing an adjusted activation period.

10. The method of claim 9, wherein a length of time between refresh indicators is an integer multiple of the adjusted activation period.

11. An apparatus for controlling backlighting of a display, comprising:
a counter;
at least one register operatively connected to the counter;
at least one latch operatively connected to the at least one register; and
at least one light-emitting diode operatively connected to the at least one latch; wherein
the at least one latch generates a latch signal controlling an operational state of the at least one light-emitting diode; and
the latch signal varies according to an output of the counter.

12. The apparatus of claim 11, wherein the at least one register comprises:
a set register operatively connected to the counter; and
a reset register operatively connected to the counter.

13. The apparatus of claim 12, wherein:
the set register generates a set output at a first output value of the counter; and
the reset register generates a reset output at a second output value of the counter.

14. The apparatus of claim 13, wherein:
the at least one latch's signal is activated in response to the set output; and
the at least one latch's signal is deactivated in response to the reset output.

15. The apparatus of claim 14, further comprising:
a second register operatively connected to the counter;
a second latch operatively connected to the at least one register; and
a second light-emitting diode operatively connected to the at least one latch; wherein
the second latch generates a second latch signal controlling an operational state of the second light-emitting diode; and
the second latch signal varies according to an output of the counter.

16. The apparatus of claim 15, wherein:
the second latch comprises a second set register operatively connected to the counter and a second reset register operatively connected to the counter;
the second set register generates a second set output at a third output value of the counter; and
the second reset register generates a second reset output at a fourth output value of the counter.

17. The apparatus of claim 16, wherein the first, second, third and fourth output values of the counter are all different.

18. The apparatus of claim 17, wherein the difference between the first and second output values equals the difference between the third and fourth output values.

19. The apparatus of claim 10, wherein the output of the counter is reset when the counter receives a portion of a synchronization signal from a video element.

20. The apparatus of claim 19, wherein the portion of a synchronization signal is an active edge of a VSYNC signal.

21. The apparatus of claim 11, further comprising a display screen at least partially backlit by the at least one light-emitting diode.
